(19) United States
(12) Patent Application Publication
(10) Pub. No.: US 2003/0078908 A1
(43) Pub. Date: Apr. 24, 2003

(54) Method and system for subscription based data exchange

(76) Inventor: Alex Paransky, LaCrescenta, CA (US)

Correspondence Address: Robert M. Schwartz, RUDEN, McCLOSKY, SMITH, SCHUSTER & RUSSELL, P.A., 200 EAST BROWARD BOULEVARD, Fort Lauderdale, FL, 33301, US

(21) Appl. No.: 10/252,769

(22) Filed: Sep. 23, 2002

Related U.S. Application Data
(60) Provisional application No. 60/324,209, filed on Sep. 21, 2001.

(51) Int. Cl. G06F 7/00

(52) U.S. Cl. 707/1

(57) ABSTRACT

A computer-implemented method for data exchange is disclosed. The method includes the steps of generating an account identifier for a target entity, creating at least one profile for the target entity, wherein the at least one profile includes at least one profile component, requesting a subscription to the at least one profile by an interested entity, generating a response to the subscription request from the interested entity by the target entity, wherein the response is at least one of an acceptance response and a denial response, and assigning the at least one profile to the subscription in acknowledgement of the acceptance response, wherein the at least one profile is accessible to the interested entity.

### CROSS-REFERENCE TO RELATED APPLICATION

This application claims the benefit of U.S. Provisional Patent Application Ser. No. 60/324,209, filed Sep. 21, 2001, entitled METHOD AND SYSTEM FOR SUBSCRIPTION BASED DATA EXCHANGE.

### BACKGROUND OF THE INVENTION

Various entities wish to remain current and updated in regards to each other's profile information. We define a profile as various components of information that pertain to a certain entity. In such a relation there exists two roles. The interested entity plays the role of an organization or an individual who is interested in staying up to date with the profile information of the target entity. A target entity is an individual or an organization that wishes to disclose some information about itself via a profile. A number of tools exist today for accomplishing this task. These tools include: basic address books, personal digital assistants (PDA), personal office tools applications, corporate specialized application such as customer relation management systems (CRM), mobile phones, and various Internet web sites.

Address books consists of a number of paper-based pages with a letter associated with each page identifying the particular page as a part of the alphabetical index. An interested entity using such tool typically copies the components of interest from the profile of the target entity onto the appropriate page chosen based on some alphabetic characteristic of target entity's profile components. Data that makes up the components of the profile remains in the address book until updated by the interested entity.

Personal digital assistants (PDA) have added many capabilities to the previously described address book. While the method of entering and displaying information has changed from pen and paper based, to a digital format, the components of the profile of the target entity is still copied into the device by the interested entity. Data defining these components remains in the PDA until updated by the interested entity.

Personal office tools applications duplicate the functional features of the address book onto a computer medium. The computer, like a PDA, changes the tool in which the components of the target entity's profile are stored. However, the method used to populate computer with necessary profile components of the target entity remains the same. Profile components are still copied by the interested entity into the computer and stored locally. Data defining the profile of the target entity remains in the computer until updated by the interested entity.

Customer Relation Management (CRM) software has added many features around the basic computer implementation of the address book, however, for the purposes of this document, it functions much similar to the personal office tools applications described above. Data of the target entity is typically copied and updated in the system by the interested entity

Websites, change the medium via which interaction with the basic phone book occurs. They also allow access to the information from various other computers, however, the data is still copied into the system and maintained by the interested party.

While the aforementioned tools vary in their nature, the method of recording profile components of the target entity by the interested entity remains the same. Typically, the interested entity copies the components of interest to it of the target entity in to a local medium presented by each of the tools. When the information about target entity changes, the interested entity updates the profile of the target entity using the tool that was previously used to capture the information or equivalent thereof.

There are a number of problems with the current method of storing target entity profile components. These problems cause the profile components that the interested entity records in regards to the target entity to become outdated.

i) The interested entity is responsible for keeping its information about target entity current, meanwhile, only the target entity knows when such information has changed.

ii) Target entity might not have the correct information needed to effectively update the interested entity when any changes to the target entity's profile take place.

iii) Even when the target entity attempts to notify all interested entities of the change of information, the notification could be missed or ignored by the interested entity.

iv) From the perspective of the target entity, the list of interested entities might be too large. It might not be possible, feasible, or practical to attempt at notifying each of the interested entities.

v) Various interested entities take interest to different profile components of the target entity. There is no mechanism for the target entity to track that profile components are of interest to a particular interested entity. Thus, when a particular component of the target entity profile changes, it is left up to the target entity discretion of who, when and how the interested entities are notified.

vi) The target entity might not be aware of all the interested entities keeping track of its profile components. Thus no notification ever takes place.

vii) There is a certain lack of control by the target entity in regards to what components of the profile are visible to the interested entity. Also, when such relationship is no longer desired, it is not possible for the interested entity modify or otherwise cancel such a relationship to the target entity.

### SUMMARY OF THE INVENTION

An embodiment of the present invention provides a method and system for keeping profile components of the target entity current with those tracked by the interested entity. The system creates an account identified by an identifier (ID) for the target entity. Target entity creates any number of profiles consisting of profile components. Target entity's profile components can be shared among multiple profiles that the target entity creates. The interested entity requests a subscription to the information maintained by the target entity. Target entity acknowledges such a subscription by assigning one or more profiles to the subscription. Alternatively the subscription can be denied by the target entity. The interested entity is able to view only the exact information entered by the target entity via the subscription. The target entity is in full control of what information is seen by the interested entity. The target entity is able to modify the contents of or cancel the subscription. The interested entity can also voluntarily cancel the subscription or further limit the access of the subscription to a subset of profiles already allocated to the subscription.

### BRIEF DESCRIPTION OF THE DRAWINGS

FIG. 1 illustrates various types of profile components.

FIG. 2 illustrates the relationship between profile and profile component.

FIG. 3 illustrates the profile subscription mechanism.

FIG. 4 illustrates the relationships between account, profile, and profile components.

FIG. 5 illustrates the user registration sequence.

FIG. 6 illustrates the user login sequence.

FIG. 7 illustrates the profile component creation sequence.

FIG. 8 illustrates the profile creation sequence.

FIG. 9 illustrates the subscription request.

FIG. 10 illustrates the subscription acknowledgement.

FIG. 11 illustrates the subscription acknowledgement (rejection).

FIG. 12 illustrates the target profile summary display.

### DETAILED DESCRIPTION OF THE INVENTION

The present invention provides a method and system for allowing a target entity to control profile components and thus control data visible to an interested entity. The subscription based system improves the accuracy of the data by allowing the target entity to update profile components as necessary, and permitting the interested entity to have access to the updated information as soon as it is made available by the target entity.

In one embodiment various entities access the system and create accounts by which they are known to the system from there on. A unique identification (ID) is assigned to each account. Entities proceed to create profiles that are made up of profile components. At a certain time an interested entity wishes to subscribe to some information having to do with the target entity. Knowing the ID of the target entity's account, the interested entity petitions the target entity for a subscription to one or more of the target's entity profiles. The target entity acknowledges the subscription of the interested entity by either assigning one or more profiles to satisfy the subscription or refusing the subscription altogether. In the case when subscription is honored by the target entity with one or more profiles, the interested entity gets immediate read-only access to the target's entity profile information that was associated with the subscription. At a later time, target entity may wish to review all the subscriptions that exist for its profiles, and cancel any subscription as needed. Target entity may also choose to modify a profile by adding or removing profile components. Target entity may also modify the data contained in the profile components that in turn effects any profiles that are sharing such components. Finally, target entity may also change the scope of the original subscription by changing the profile or profiles that are currently assigned to the subscription. When such changes are made, interested entity has the opportunity to see the changes immediately. In addition, the system can generate notifications informing interested entity of any changes to the target profiles associated with any subscriptions.

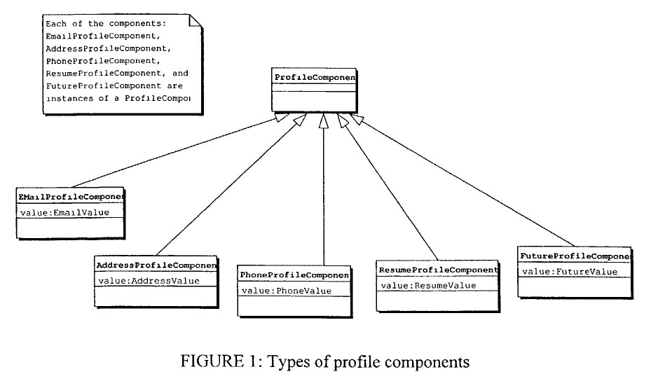

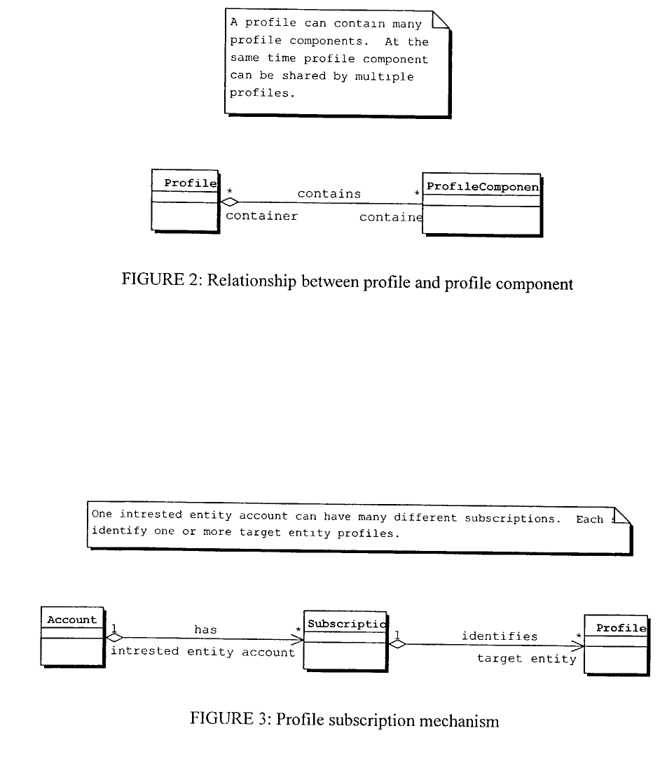

A profile component is a piece of information that an entity wishes to use in construction of the profile (FIG. 1). One such component can be an e-mail address component allowing storage of a single e-mail address value. Another example of a component could be a phone number component allowing storage of a single phone number value. An address component could allow storage of a single address value. Finally, a resume component can be used to store a value of a resume document. Many and all components capable of conveying some entity information can be envisioned and integrated into this system. Profile components can be shared among different profiles (FIG. 2). Thus a change to a profile component shared by multiple profiles effectively changes each of the profiles within which the profile component is contained.

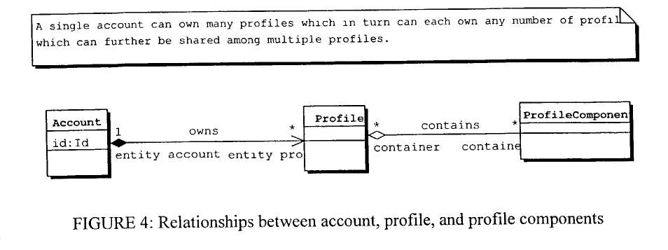

A profile is a collection of profile components defining a single element that can be attached to a target entity account via a subscription (FIG. 3). An account for a particular entity could contain any number of profiles (FIG. 4). Each profile can consist of any combination of profile components. Profiles, when attached to a subscription, make their constituent profile components visible to the interested entity. Adding or removing any of the components or can change a profile by changing any of the components' value. Profiles in the account can only be changed by the account that owns them or has been given explicit rights to modify such profiles.

New User Registration

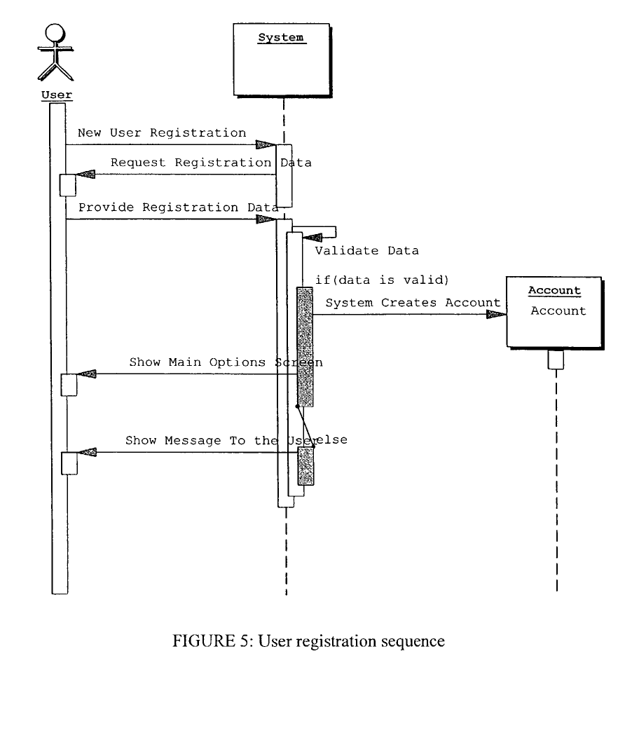

FIG. 5 illustrates account creation in a one embodiment of the method of present invention. User indicates to the system that he/she desires to register on the system. The system requests registration data such as user password. User responds with necessary information. System validates to make sure that the information is valid. If information is valid, an account is created for the user. Account ID is identified to the user as the system places user into the main options menu. If system deems the data invalid, a message is displayed to the user alerting him/her to this fact, and another request to obtain information is attempted.

Existing User Login

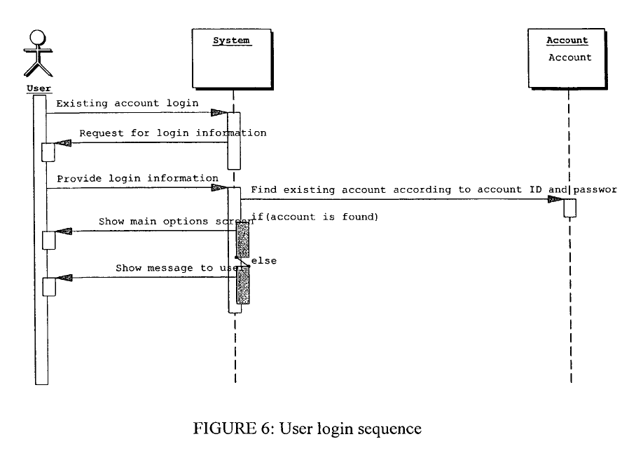

FIG. 6 illustrates a typical user login in one embodiment of the method of the present invention. User indicates to the system that he/she wishes to logon, the system responds with the request for account ID and password. User supplies the necessary information to the system. The system attempts to find already existing account with the ID indicated by the user. Once such an account is found, password supplied by the user is verified with that of the account. If verification succeeds, an options screen is presented to the user. If verification fails, user receives a message indicating the fact and is prompted for login information again.

Profile Component Creation

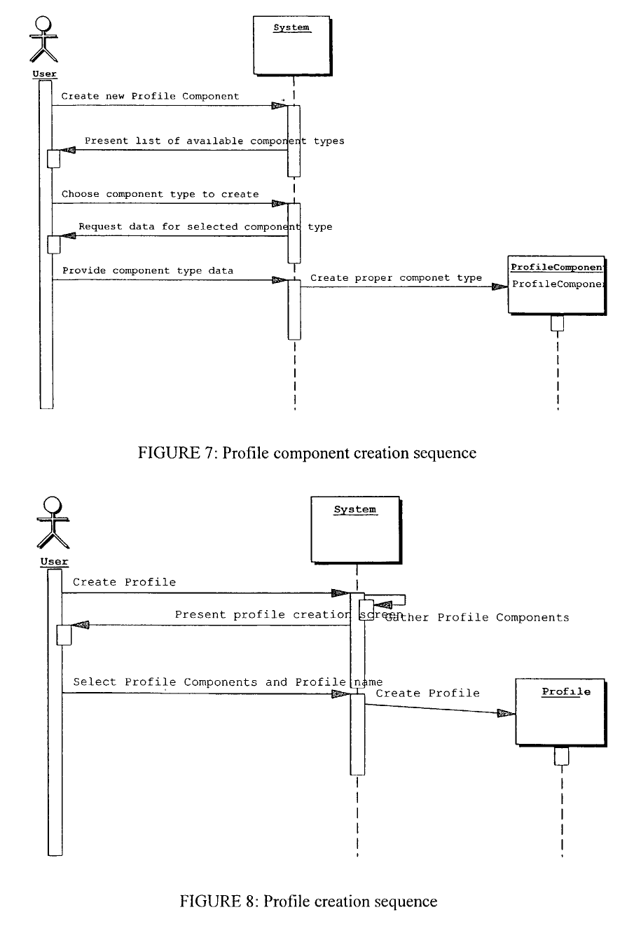

FIG. 7 illustrates the creation of profile component. User chooses to create a profile component. System asks the user for the type of the profile component he/she wishes to create. User chooses from a list of available components. An entry screen is presented allowing user to enter the information for the Value of the profile component as well as the name for this profile component. Entry screens vary by component type.

Profile Creation

FIG. 8 presents the creation of a profile. User chooses to create a new profile. The system gathers a collection of profile components existing for this user and presents user with a profile creation screen. User indicates to the system the name for a new profile, and which profile components will make up the new profile. The system creates a new user profile.

Subscription Process

Overview

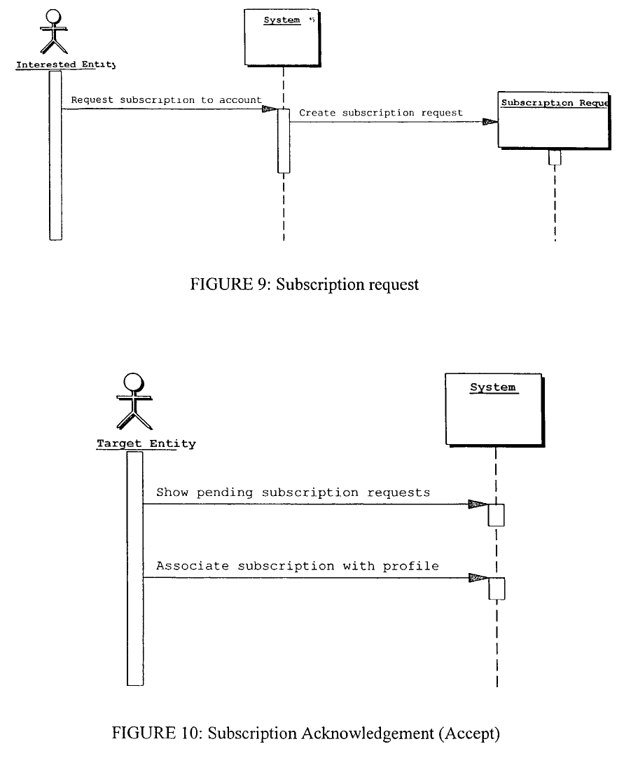

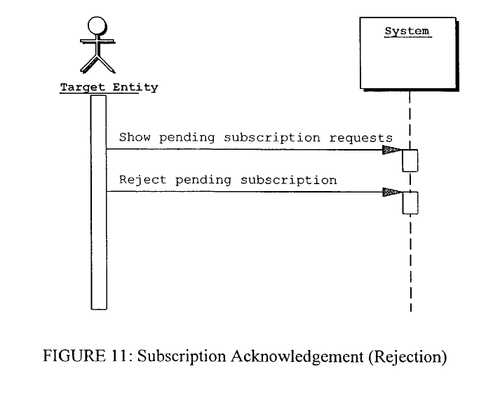

FIGS. 9, 10 and 11 present the profile subscription mechanism. In FIG. 9, interested entity requests a subscription from the target entity. Target entity acknowledges the subscription request by assigning it a profile from a set of profiles already existing in the target entity's account (FIG. 10). Once the subscription has been assigned to a profile, the interested entity is able to see target entity's profile. Target entity may also choose to reject a subscription as demonstrated in FIG. 11.

### EXAMPLE

John and Fred meet at a business meeting. They both have an account and a number of profiles established in the system. During the meeting John gives his account ID to Fred, and Fred gives his account id to John. Later, John indicates to the system that he wishes to subscribe to a profile published by Fred by creating a new subscription request with the ID of Fred's account. John is the interested entity and Fred is the target entity. Later, Fred learns that there is a new subscription request pending in his account. Fred logs on to the system and determines that the subscription request is from John. Fred acknowledges the subscription request by assigning it to his business profile.

Target Profiles Display

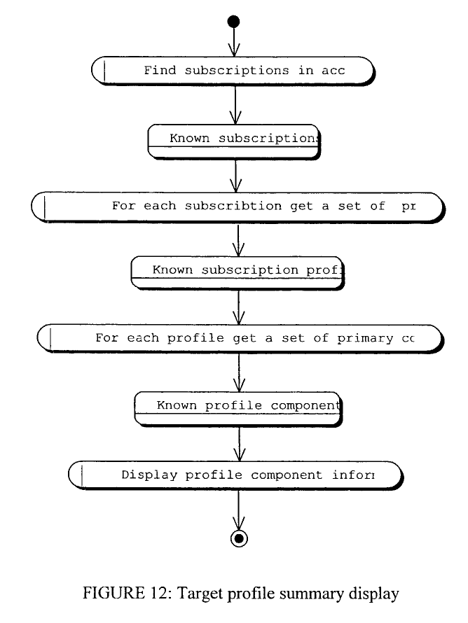

An interested entity logs on to the system using the account id previously assigned. By accessing subscribed profiles section, the interested entity can view the profiles published by the various target entities. To display the information, the system begins by examining the subscriptions existing for the current interested entity. For each subscription, the system finds the target entity profiles that are associated with the subscription, and displays key information from each profile on a summary screen. Interested user can expand on the profile summary data by requesting that the system provides a more detailed level of the profile display for a particular target profile. The system responds, by showing all the profile components assigned to the target profile by the target entity. FIG. 12 demonstrates the actions system takes to display profile summary information.

Subscription Display

A target entity can choose to display the subscriptions that are being hosted from its account. The subscription display allows target entity a quick overview of who is accessing and has the capability to the profiles in the target entity's accounts.

What is claimed is:

1. A computer-implemented method for data exchange, said method comprising the steps of:
generating an account identifier for a target entity;
creating at least one profile for said target entity, wherein said at least one profile includes at least one profile component;
requesting a subscription to said at least one profile by an interested entity;
generating a response to said subscription request from said interested entity by said target entity, wherein said response is at least one of an acceptance response and a denial response; and
assigning said at least one profile to said subscription in acknowledgement of said acceptance response, wherein said at least one profile is accessible to said interested entity.
